(19) United States
(12) Patent Application Publication
(10) Pub. No.: US 2026/0329862 A1
(43) Pub. Date: Oct. 22, 2026

(54) SYSTEM AND METHOD FOR DISTRIBUTED DATABASE DYNAMICS PROVISIONING

(71) Applicant: JPMorgan Chase Bank, N.A., New York, NY (US)

(72) Inventors: Daniel WILSON, Bangalore (IN); Saurabh SRIVASTAVA, Bengaluru (IN); Amit Kumar MESHRAM, Romansville, PA (US); Nishith ANANT, Bangalore (IN); Divya GANGIGUNTA, Jamshedpur (IN); Shreya SHREE, Bengaluru (IN); Nagendra TOKALA, Nuzvid (IN); Pratyush SAHU, Bhubaneshwar (IN)

(73) Assignee: JPMorgan Chase Bank, N.A., New York, NY (US)

(21) Appl. No.: 19/566,556

(22) Filed: Mar. 13, 2026

(30) Foreign Application Priority Data
Apr. 22, 2025 (IN) 202511038360

(51) Int. Cl. G06F 16/2453; G06F 16/27

(52) U.S. Cl. CPC G06F 16/24542; G06F 16/27

(57) ABSTRACT

Various methods, systems, and media for provisioning distributed database dynamics are disclosed. A processor establishes a communication link among an application, an application server, a distributed database, a timeseries database, and a dashboard via a communication network; receives, via the distributed database, a database query from the application; intercepts and reads, via the application server, a response including query metrics data from the distributed database corresponding to receiving the database query prior to sending the response to the application; stores aggregated data in-memory after filtering unnecessary data within the application server for accessing and processing; transfers in-memory data from the application server to the timeseries database; querying, by the dashboard, the timeseries database; continuously tracks query response times and automatically generates an alert if they exceed a configurable threshold; and creates a ticket to resolve the query response time, volume, and error counts without compromising performance of the application.

### CROSS-REFERENCE TO RELATED APPLICATIONS

This application claims the benefit of priority from Indian Patent Application No. 202511038360, filed Apr. 22, 2025, which is herein incorporated by reference in its entirety.

### TECHNICAL FIELD

This disclosure generally relates to distributed database, and, more particularly, to methods and apparatuses for implementing a platform, language, cloud, and database agnostic distributed database dynamics provisioning module for automatically capturing detailed database query-level metrics without impacting application performance.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Developments in computer and networking technology have given rise to applications that may require massive amounts of data storage for optimal performance. For example, tens of millions of users may create applications and upload them to a distributed network environment. Frameworks exist that may support large-scale data-intensive distributed applications, by enabling applications to interact with a cluster of thousands of computers (also referred to as nodes) and petabytes of data.

For example, in an organizational setting, an Apache® Cassandra™ Database may be utilized as a primary data store for the applications. Apache® Cassandra™ is a free and open-source database management system designed to handle large volumes of data across multiple commodity servers. Typically, Cassandra™ clusters may have hundreds of nodes distributed across multiple data centers. Various applications, operating in a distributed environment, perform parallel read and write operations on these Cassandra™ clusters. When performance issues arise within this complex infrastructure, identifying and resolving the root causes may prove to be challenging in real-time. Few such exemplary challenges may include application performance issues, Cassandra™ cluster issues, and cascading issues.

Regarding the application performance issues, the challenges may be that the application may connect to remote data center rather than the local data center; the query parameters may be misconfigured; private cloud pool or a specific executor may be experiencing hardware or software malfunctions, etc. Regarding the Cassandra™ cluster issues, the challenges may include latency at the node or data center level, potentially due to hardware, software, or network issues, etc. Regarding the cascading effects issues, one challenge may include that the execution of one application impacting the performance of another application, e.g., morning batch may affect the application programming interface execution, thereby substantially impacting performance of an application.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic distributed database dynamics provisioning module configured to create custom generic code, designed to seamlessly integrate with any application to automatically capture detailed database query-level metrics without impacting application performance, but the disclosure is not limited thereto.

For example, the distributed database dynamics provisioning module disclosed herein may be configured to collect information about an infrastructure where an application is deployed and running, infrastructure where application is connected to execute query (i.e., distributed database node), detailed Query level metrics data, application caller details data, query execution time data, query error details data, etc., but the disclosure is not limited thereto. In some embodiments, the distributed database dynamics provisioning module disclosed herein may also be configured to seamlessly integrate with firmwide metrics tool to collect detailed metrics. The metrics may then be visualized on a dashboard in real time.

For example, the distributed database dynamics provisioning module disclosed herein may be configured to: provide real time monitoring and diagnosing issues, e.g., facilitating real-time tracking of database objects and hardware health in a distributed environment without affecting application performance; timely identify any latency issues at both the node and data center levels, helping in quick resolution to improve overall system performance; accurately identify and pinpoint the root cause of performance issues originating from a database, whether they stem from incorrect data center connections, misconfigured query parameters, or hardware/software malfunctions; significantly improve database related investigative processing time; provide insights into how the execution of one application may affect another, allowing developers to address cascading effects efficiently; optimize data center connections, e.g., identifying that applications connect to the appropriate local data center, minimizing latency; configuring query parameters, e.g., detecting misconfigured query parameters to enhance data retrieval performance, but the disclosure is not limited thereto.

In some embodiments, the distributed database dynamics provisioning module disclosed herein may also be configured to improve operational efficiency. For example, with granular error query analysis, the distributed database dynamics provisioning module may facilitate early detection and alerting of system anomalies, minimizing downtime and improving system reliability. Automatic resolution may also be integrated with alerts, thereby reducing human intervention and improving overall system performance. Moreover, the distributed database dynamics provisioning module disclosed herein may be configured to implement intuitive user interface thereby ensuring accessibility for both technical and non-technical stakeholders, promoting cross-functional collaboration and informed decision-making, but the disclosure is not limited thereto.

In some embodiments, a method for provisioning distributed database dynamics corresponding to an application by utilizing one or more processors along with allocated memory is disclosed. The method may include: establishing a communication link among the application, an application server, a distributed database, a timeseries database, and a dashboard via a communication network; receiving, by the distributed database, a database query from the application; intercepting and reading, by the application server, a response including query metrics data from the distributed database corresponding to receiving the database query prior to sending the response to the application; extracting essential data from the response for metric object formation and filtering out unnecessary data; generating aggregated data by calculating and providing statistical measures corresponding to the extracted essential data; storing the aggregated data in-memory within the application server for accessing and processing; transferring the in-memory data from the application server to the timeseries database; querying, by the dashboard, the timeseries database and continuously tracking query response times; automatically generating an alert, in response to continuously tracking, when it is determined that a query response time, volume, and error counts exceed a configurable threshold; creating a ticket, in response to the alert, to take a remedial action to resolve the query response time, volume, and error counts of a data center within the distributed database dynamics corresponding to the application; and resolving the query response time, volume, and error counts, in response to the ticket, without compromising performance of the application.

In some embodiments according to the method, the essential data for metric objection formation may include one or more of the following data: data center information data, query details data, status data, execution time data, host internet protocol data, etc., but the disclosure is not limited thereto.

In some embodiments according to the method, the unnecessary data may include one or more of the following data: specific query types data; responses with a time greater than a configurable threshold, irrelevant metric types data, etc., but the disclosure is not limited thereto.

In some embodiments, the method may further include: enriching the metric object by adding private cloud pool details data, executor details data, and application caller details data.

In some embodiments, the method may further include: masking and transforming data from the response including masking personally identifiable information, grouping client identifies to form client groups, and masking host internet protocols to optimize time metric counts, but the disclosure is not limited thereto.

In some embodiments according to the method, the statistical measures may include minimum values, maximum values, percentiles corresponding to a response time of a data center corresponding to the database query from the application, etc., but the disclosure is not limited thereto.

In some embodiments, the method may further include: performing periodic clean-up of outdated metric data from the in-memory data to optimize memory usage.

In some embodiments according to the method, the timeseries database may be shared across all services and executors corresponding to the application.

In some embodiments, a system for provisioning distributed database dynamics corresponding to an application is disclosed. The system may include: a processor; and a memory operatively connected to the processor via a communication interface, the memory storing computer readable instructions, when executed, may cause the processor to: establish a communication link among the application, an application server, a distributed database, a timeseries database, and a dashboard via a communication network; receive, by the distributed database, a database query from the application; intercept and read, by the application server, a response including query metrics data from the distributed database corresponding to receiving the database query prior to sending the response to the application; extract essential data from the response for metric object formation and filter out unnecessary data; generate aggregated data by calculating and providing statistical measures corresponding to the extracted essential data; store the aggregated data in-memory within the application server for accessing and processing; transfer the in-memory data from the application server to the timeseries database; query, by the dashboard, the timeseries database and continuously tracking query response times; automatically generate an alert, in response to continuously tracking, when it is determined that a query response time, volume, and error counts exceed a configurable threshold; create a ticket, in response to the alert, to take a remedial action to resolve the query response time, volume, and error counts of a data center within the distributed database dynamics corresponding to the application; and resolve the query response time, volume, and error counts, in response to the ticket, without compromising performance of the application.

In some embodiments according to the system, the essential data for metric objection formation may include one or more of the following data: data center information data, query details data, status data, execution time data, host internet protocol data, etc., but the disclosure is not limited thereto.

In some embodiments according to the system, the unnecessary data may include one or more of the following data: specific query types data; responses with a time greater than a configurable threshold, irrelevant metric types data, etc., but the disclosure is not limited thereto.

In some embodiments, the processor may be further configured to: enrich the metric object by adding private cloud pool details data, executor details data, and application caller details data.

In some embodiments, the processor may be further configured to: mask and transform data from the response including masking personally identifiable information, grouping client identifies to form client groups, and masking host internet protocols to optimize time metric counts, but the disclosure is not limited thereto.

In some embodiments according to the system, the statistical measures may include minimum values, maximum values, percentiles corresponding to a response time of a data center corresponding to the database query from the application, etc., but the disclosure is not limited thereto.

In some embodiments, the processor may be further configured to: perform periodic clean-up of outdated metric data from the in-memory data to optimize memory usage.

In some embodiments according to the system, the timeseries database may be shared across all services and executors corresponding to the application.

In some embodiments, a non-transitory computer readable medium configured to store instructions for provisioning distributed database dynamics corresponding to an application is disclosed. The instructions, when executed, may cause a processor to perform the following: establishing a communication link among the application, an application server, a distributed database, a timeseries database, and a dashboard via a communication network; receiving, by the distributed database, a database query from the application; intercepting and reading, by the application server, a response including query metrics data from the distributed database corresponding to receiving the database query prior to sending the response to the application; extracting essential data from the response for metric object formation and filtering out unnecessary data; generating aggregated data by calculating and providing statistical measures corresponding to the extracted essential data; storing the aggregated data in-memory within the application server for accessing and processing; transferring the in-memory data from the application server to the timeseries database; querying, by the dashboard, the timeseries database and continuously tracking query response times; automatically generating an alert, in response to continuously tracking, when it is determined that a query response time, volume, and error counts exceed a configurable threshold; creating a ticket, in response to the alert, to take a remedial action to resolve the query response time, volume, and error counts of a data center within the distributed database dynamics corresponding to the application; and resolving the query response time, volume, and error counts, in response to the ticket, without compromising performance of the application.

In some embodiments according to the non-transitory computer readable medium, the essential data for metric objection formation may include one or more of the following data: data center information data, query details data, status data, execution time data, host internet protocol data, etc., but the disclosure is not limited thereto.

In some embodiments according to the non-transitory computer readable medium, the unnecessary data may include one or more of the following data: specific query types data; responses with a time greater than a configurable threshold, irrelevant metric types data, etc., but the disclosure is not limited thereto.

In some embodiments, the instructions, when executed, may cause the processor to further perform the following: enriching the metric object by adding private cloud pool details data, executor details data, and application caller details data.

In some embodiments, the instructions, when executed, may cause the processor to further perform the following: masking and transforming data from the response including masking personally identifiable information, grouping client identifies to form client groups, and masking host internet protocols to optimize time metric counts.

In some embodiments according to the non-transitory computer readable medium, the statistical measures may include minimum values, maximum values, percentiles corresponding to a response time of a data center corresponding to the database query from the application, etc., but the disclosure is not limited thereto.

In some embodiments, the instructions, when executed, may cause the processor to further perform the following: performing periodic clean-up of outdated metric data from the in-memory data to optimize memory usage.

In some embodiments according to the non-transitory computer readable medium, the timeseries database may be shared across all services and executors corresponding to the application.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic distributed database dynamics provisioning module configured to automatically capture detailed database query-level metrics without impacting application performance in accordance with an embodiment.

FIG. 2 illustrates a diagram of a network environment with a platform, language, database, and cloud agnostic distributed database dynamics provisioning device in accordance with an embodiment.

FIG. 3 illustrates a system diagram for implementing a platform, language, database, and cloud agnostic distributed database dynamics provisioning device having a platform, language, database, and cloud agnostic distributed database dynamics provisioning module in accordance with an embodiment.

FIG. 4 illustrates a system diagram for implementing a platform, language, database, and cloud agnostic distributed database dynamics provisioning module of FIG. 3 in accordance with an embodiment.

FIG. 5 illustrates a flow chart of a process implemented by the platform, language, database, and cloud agnostic distributed database dynamics provisioning module of FIG. 4 for automatically capturing detailed database query-level metrics without impacting application performance in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art may appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

Advancements in distributed computing and networked storage systems have enabled deployment of large-scale, data-intensive applications across geographically distributed computing environments. Such environments may include clusters comprising hundreds or thousands of physical or virtual computing nodes interconnected over one or more networks. These nodes may collectively store and process petabytes of structured or unstructured data. Applications executing within these environments may perform high-volume, low-latency read and write operations across multiple storage nodes in parallel, thereby placing substantial demands on processing, memory, storage, and network resources.

In certain implementations, a distributed NoSQL database management system, such as Cassandra™, may be deployed as a primary data store. Such database systems are architected to provide horizontal scalability and fault tolerance across multiple commodity servers, often spanning multiple data centers. A database cluster may include hundreds of nodes configured to replicate data and service concurrent client requests. Applications executing within the distributed environment may concurrently access the cluster using asynchronous or parallel operations. Under these conditions, resource contention, replication delays, network latency, or node-level performance degradation may adversely affect overall system throughput and response time..

Regarding application performance issues, the challenges may be that the application may connect to remote data center rather than the local data center; the query parameters may be misconfigured; private cloud pool or a specific executor may be experiencing hardware or software malfunctions, etc. Regarding the Cassandra™ cluster issues, the challenges may include latency at the node or data center level, potentially due to hardware, software, or network issues, etc. Regarding the cascading effects issues, one challenge may include that the execution of one application impacting on the performance of another application, e.g., morning batch may affect the application programming interface execution, thereby substantially impacting performance of an application. Thus, today’s conventional tools fail to capture detailed database query-level metrics without impacting application performance.

As mentioned earlier, performance degradation within a distributed database environment may arise from a variety of infrastructure-level conditions. For example, an application instance may establish connections to a non-local data center, thereby increasing network round-trip time and introducing latency. In other scenarios, improperly configured query parameters, thread pools, connection pools, or execution frameworks may result in inefficient resource utilization. Additionally, hardware faults, storage I/O bottlenecks, memory pressure, or network congestion at the node or data center level may impact cluster performance. Because multiple applications may share common computing and storage resources, resource-intensive execution by one application may propagate performance degradation to other applications through shared infrastructure constraints, resulting in cascading latency or throughput reduction across the distributed system.

The disclosed embodiments implement a platform, language, cloud, and database agnostic distributed database dynamics provisioning module configured to create custom generic code, designed to seamlessly integrate with any application to automatically capture detailed database query-level metrics without impacting application performance, but the disclosure is not limited thereto. For example, the distributed database dynamics provisioning module disclosed herein may be configured to collect information about an infrastructure where an application is deployed and running, infrastructure where application is connected to execute query (i.e., distributed database node), detailed Query level metrics data, application caller details data, query execution time data, query error details data, etc., but the disclosure is not limited thereto. In some embodiments, the distributed database dynamics provisioning module disclosed herein may also be configured to seamlessly integrate with firmwide metrics tool to collect detailed metrics. The metrics may then be visualized on a dashboard in real time for taking remedial action.

While many of the exemplary embodiments discussed herein focus on applications in distributed database domain, it should be understood that the technology described herein may be applied to a wide variety of other application domains.

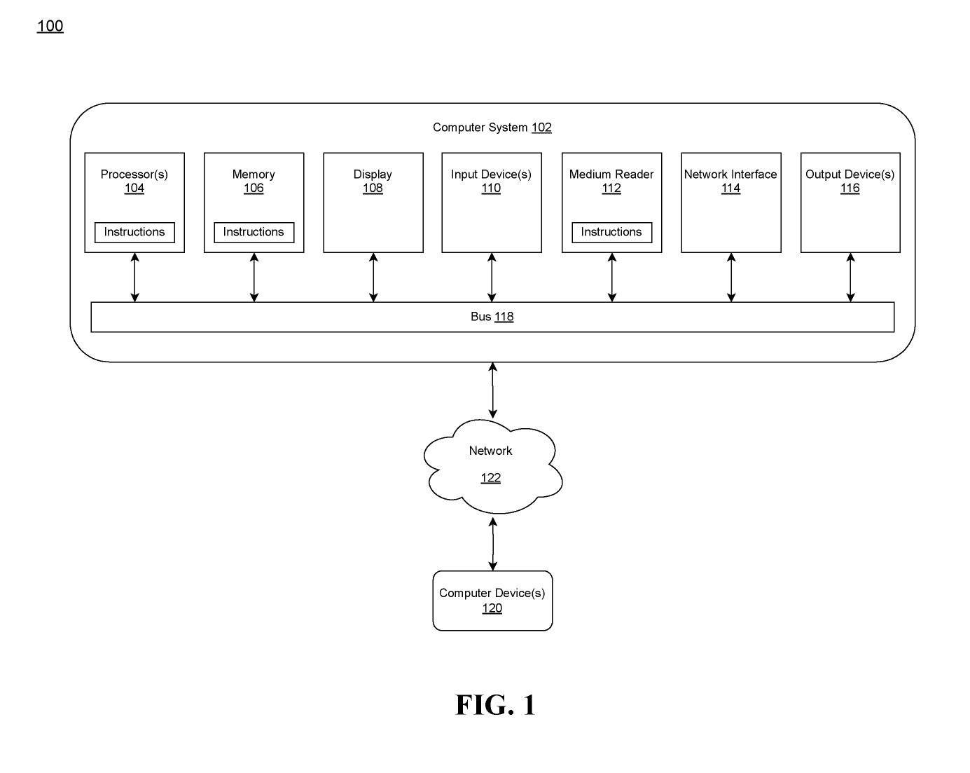

FIG. 1 is an exemplary system 100 for use in implementing a platform, language, database, and cloud agnostic distributed database dynamics provisioning module configured to create custom generic code, designed to seamlessly integrate with any application to automatically capture detailed database query-level metrics without impacting application performance, but the disclosure is not limited thereto. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that may last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that may last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the distributed database dynamics provisioning module may be platform, language, database, and cloud agnostic that may allow for consistent easy orchestration and passing of data through various components of the distributed database dynamics provisioning module to output a desired result, i.e., alerts to remedy latency issues, regardless of platform, browser, language, database, and cloud environment. Since the disclosed process, in some embodiments, may be platform, language, database, browser, and cloud agnostic, the distributed database dynamics provisioning module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionality as described herein, and a processor described herein may be used to support a virtual processing environment.

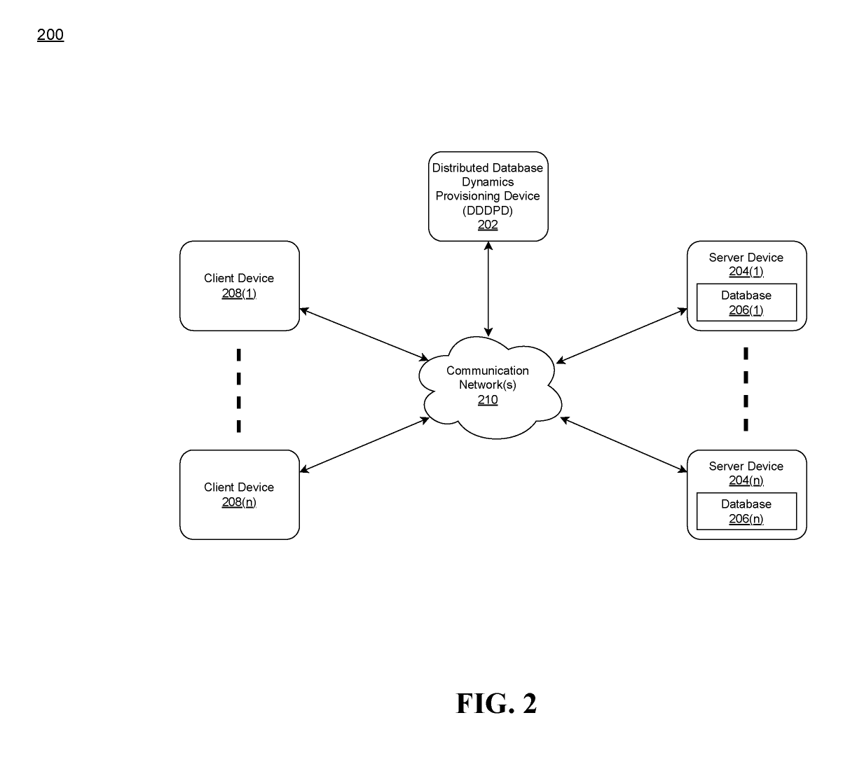

Referring to FIG. 2, a schematic of an exemplary network environment 200 for implementing a language, platform, database, and cloud agnostic distributed database dynamics provisioning device (DDDPD) of the instant disclosure is illustrated.

In some embodiments, the above-described problems associated with conventional tools may be overcome by implementing an DDDPD 202 as illustrated in FIG. 2 that may be configured for implementing a platform, language, database, and cloud agnostic distributed database dynamics provisioning module configured to automatically create custom generic code, designed to seamlessly integrate with any application to automatically capture detailed database query-level metrics without impacting application performance, but the disclosure is not limited thereto. For example, the distributed database dynamics provisioning module within the DDDPD 202 disclosed herein may be configured to collect information about an infrastructure where an application is deployed and running, infrastructure where application is connected to execute query (i.e., distributed database node), detailed Query level metrics data, application caller details data, query execution time data, query error details data, etc., but the disclosure is not limited thereto. In some embodiments, the distributed database dynamics provisioning module disclosed herein may also be configured to seamlessly integrate with firmwide metrics tool to collect detailed metrics. The metrics may then be visualized on a dashboard in real time.

In some embodiments, the distributed database dynamics provisioning module within the DDDPD 202 disclosed herein may be configured to: provide real time monitoring and diagnosing issues, e.g., facilitating real-time tracking of database objects and hardware health in a distributed environment without affecting application performance; timely identify any latency issues at both the node and data center levels, helping in quick resolution to improve overall system performance; accurately identify and pinpoint the root cause of performance issues originating from a database, whether they stem from incorrect data center connections, misconfigured query parameters, or hardware/software malfunctions; significantly improve database related investigative processing time; provide insights into how the execution of one application may affect another, allowing developers to address cascading effects efficiently; optimize data center connections, e.g., identifying that applications connect to the appropriate local data center, minimizing latency; configuring query parameters, e.g., detecting misconfigured query parameters to enhance data retrieval performance, but the disclosure is not limited thereto.

The DDDPD 202 may have one or more computer system 102s, as described with respect to FIG. 1, which in aggregate provide the necessary functions.

The DDDPD 202 may store one or more applications that may include executable instructions that, when executed by the DDDPD 202, cause the DDDPD 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DDDPD 202 itself, may be located in virtual server(s) running in a cloud-based computing environment rather than being tied to one or more specific physical network computing devices. Also, the application(s) may be running in one or more virtual machines (VMs) executing on the DDDPD 202. Additionally, in one or more embodiments of this technology, virtual machine(s) running on the DDDPD 202 may be managed or supervised by a hypervisor.

In the network environment 200 of FIG. 2, the DDDPD 202 may be coupled to a plurality of server devices 204(1)-204(n) that hosts a plurality of databases 206(1)-206(n), and also to a plurality of client devices 208(1)-208(n) via communication network(s) 210. A communication interface of the DDDPD 202, such as the network interface 114 of the computer system 102 of FIG. 1, operatively couples and communicates between the DDDPD 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DDDPD 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus may not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The DDDPD 202 may be a standalone device or integrated with one or more other devices or apparatuses, such as one or more of the server devices 204(1)-204(n). In some embodiments, the DDDPD 202 may be hosted by one of the server devices 204(1)-204(n), and other arrangements may also be possible. Moreover, one or more of the devices of the DDDPD 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the DDDPD 202 via the communication network(s) 210 according to the HTTP-based and/or JSON protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the DDDPD 202 that may efficiently provide a platform for implementing a platform, language, database, and cloud agnostic distributed database dynamics provisioning module configured to automatically create custom generic code, designed to seamlessly integrate with any application to automatically capture detailed database query-level metrics without impacting application performance and providing the other technological improvements mentioned earlier, but the disclosure is not limited thereto.

The client devices 208(1)-208(n) may run interface applications, such as standard web browsers or standalone client applications, which may provide an interface to communicate with the DDDPD 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the DDDPD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the DDDPD 202, the server devices 204(1)-204(n), or the client devices 208(1)-208(n), in some embodiments, may be configured to operate as virtual instances on the same physical machine. In some embodiments, one or more of the DDDPD 202, the server devices 204(1)-204(n), or the client devices 208(1)-208(n) may operate on the same physical device rather than as separate devices communicating through communication network(s) 210. Additionally, there may be more or fewer DDDPDs 202, server devices 204(1)-204(n), or client devices 208(1)-208(n) than illustrated in FIG. 2. In some embodiments, the DDDPD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

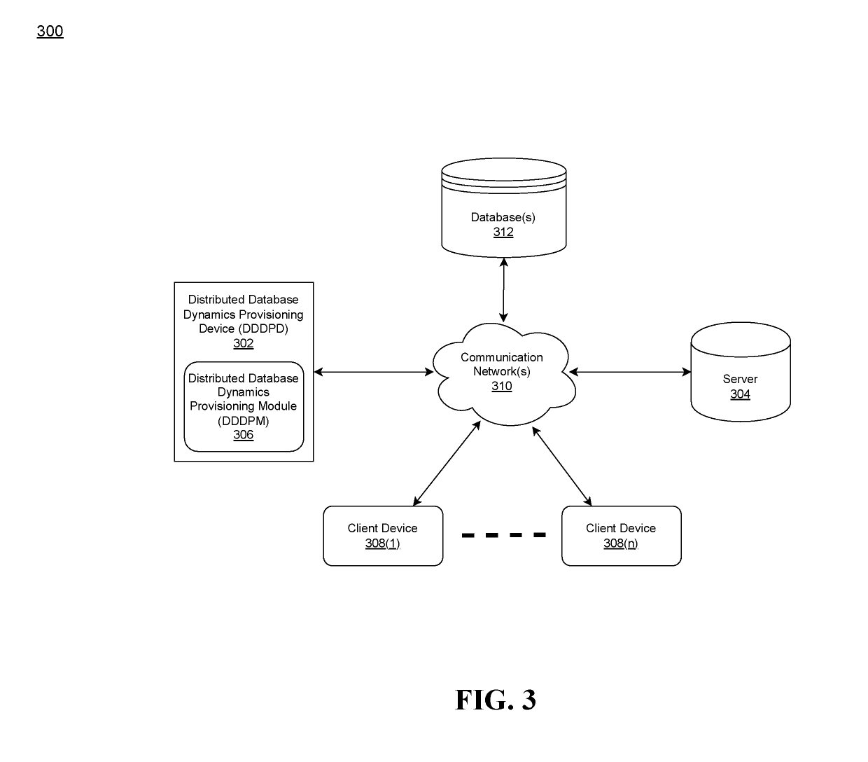

FIG. 3 illustrates a system diagram for implementing a platform, language, and cloud agnostic DDDPD having a platform, language, database, and cloud agnostic distributed database dynamics provisioning module (DDDPM) in accordance with an embodiment.

As illustrated in FIG. 3, the system 300 may include an DDDPD 302 within which an DDDPM 306 may be embedded, a server 304, a database(s) 312, a plurality of client devices 308(1) … 308(n), and a communication network 310.

In some embodiments, the DDDPD 302 including the DDDPM 306 may be connected to the server 304, and the database(s) 312 via the communication network 310. The DDDPD 302 may also be connected to the plurality of client devices 308(1) … 308(n) via the communication network 310, but the disclosure is not limited thereto.

According to exemplary embodiment, the DDDPD 302 is described and shown in FIG. 3 as including the DDDPM 306, although it may include other rules, policies, modules, databases, or applications, etc. In some embodiments, the database(s) 312 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto.

In some embodiments, the DDDPM 306 may be configured to receive real-time feed of data from the plurality of client devices 308(1) … 308(n) and secondary sources via the communication network 310.

As may be described below, the DDDPM 306 may be configured to: establish a communication link among the application, an application server, a distributed database, a timeseries database, and a dashboard via a communication network; receive, by the distributed database, a database query from the application; intercept and read, by the application server, a response including query metrics data from the distributed database corresponding to receiving the database query prior to sending the response to the application; extract essential data from the response for metric object formation and filter out unnecessary data; generate aggregated data by calculating and providing statistical measures corresponding to the extracted essential data; store the aggregated data in-memory within the application server for accessing and processing; transfer the in-memory data from the application server to the timeseries database; query, by the dashboard, the timeseries database and continuously tracking query response times; automatically generate an alert, in response to continuously tracking, when it is determined that a query response time, volume, and error counts exceed a configurable threshold; create a ticket, in response to the alert, to take a remedial action to resolve the query response time, volume, and error counts of a data center within the distributed database dynamics corresponding to the application; and resolve the query response time, volume, and error counts, in response to the ticket, without compromising performance of the application, but the disclosure is not limited thereto.

The plurality of client devices 308(1) … 308(n) are illustrated as being in communication with the DDDPD 302. In this regard, the plurality of client devices 308(1) … 308(n) may be “clients” (e.g., customers) of the DDDPD 302 and are described herein as such. Nevertheless, it is to be known and understood that the plurality of client devices 308(1) … 308(n) need not necessarily be “clients” of the DDDPD 302, or any entity described in association therewith herein. Any additional or alternative relationship may exist between either or both of the plurality of client devices 308(1) … 308(n) and the DDDPD 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) … 308(n) may communicate with the DDDPD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The DDDPD 302 may be the same or similar to the DDDPD 202 as described with respect to FIG. 2, including any features or combination of features described with respect thereto.

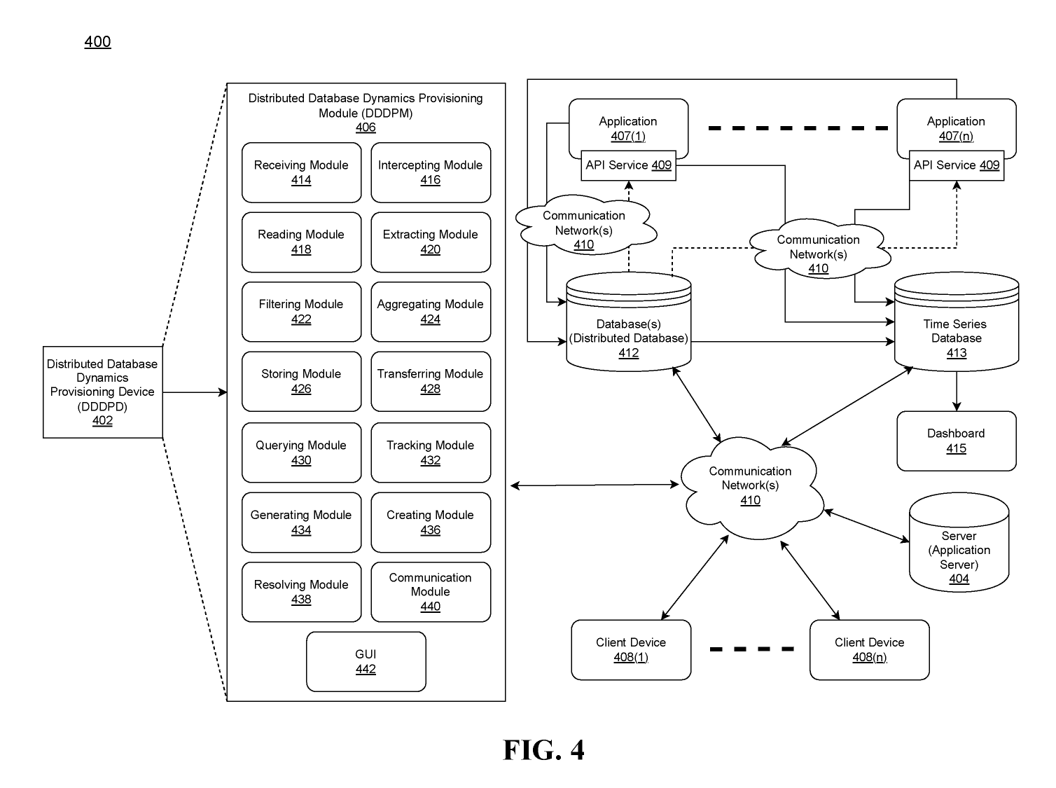

FIG. 4 illustrates a system diagram for implementing a platform, language, database, and cloud agnostic DDDPM of FIG. 3 in accordance with an exemplary embodiment.

In some embodiments, the system 400 may include a platform, language, database, and cloud agnostic DDDPD 402 within which a platform, language, database, and cloud agnostic DDDPM 406 may be embedded, a server 404 (i.e., application server), a plurality of applications 407(1)-407(n) each having an API service 409, a communication network 410, a database 412 (i.e., a distributed database), a time series database 413, and a dashboard 415. In some embodiments, the application server 404 may comprise a plurality of servers located centrally or located in different locations, but the disclosure is not limited thereto.

In some embodiments, the DDDPD 402 including the DDDPM 406 may be connected to the application server 404, the plurality of applications 407(1)-407(n), the distributed database 412, the time series database 413, and the dashboard 415 via the communication network 410. The DDDPD 402 may also be connected to the plurality of client devices 408(1)-408(n) via the communication network 410, but the disclosure is not limited thereto. The DDDPM 406, the application server 404, the plurality of client devices 408(1)-408(n), the database(s) 412, 413 the communication network 410 as illustrated in FIG. 4 may be the same or similar configuration to the DDDPM 306, the server 304, the plurality of client devices 308(1)-308(n), the database(s) 312, the communication network 310, respectively, as illustrated in FIG. 3.

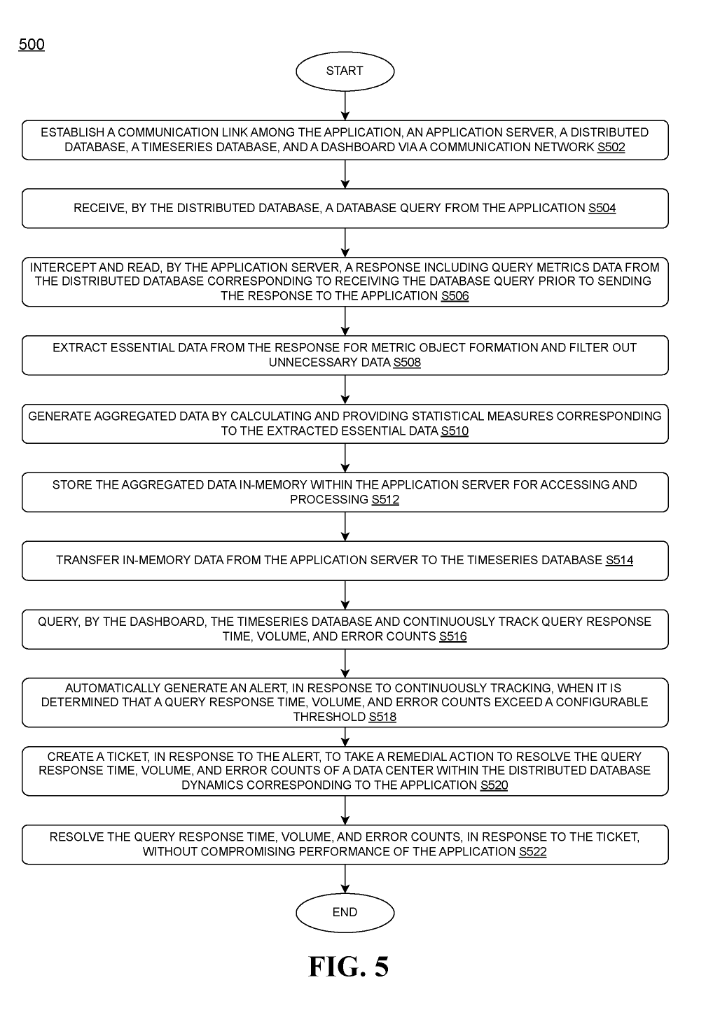

In some embodiments, as illustrated in FIG. 4, the DDDPM 406 may include a receiving module 414, an intercepting module 416, a reading module 418, an extracting module 420, a filtering module 422, an aggregating module 424, a storing module 426, a transferring module 428, a querying module 430, a tracking module 432, a generating module 434, a creating module 436, a resolving module 438, a communication module 440 and a Graphical User Interface (GUI) 442. In some embodiments, interactions and data exchange among these modules included in the DDDPM 406 provide the advantageous effects of the disclosed invention. Functionalities of each module of FIG. 4 may be described in detail below with reference to FIGS. 4-5.

In some embodiments, each of the receiving module 414, intercepting module 416, reading module 418, extracting module 420, filtering module 422, aggregating module 424, storing module 426, transferring module 428, querying module 430, tracking module 432, generating module 434, creating module 436, resolving module 438, and the communication module 440 of the DDDPM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the receiving module 414, intercepting module 416, reading module 418, extracting module 420, filtering module 422, aggregating module 424, storing module 426, transferring module 428, querying module 430, tracking module 432, generating module 434, creating module 436, resolving module 438, and the communication module 440 of the DDDPM 406 of FIG. 4 may be implemented by microprocessors or similar, and may be programmed using software (e.g., microcode) to perform various functions discussed herein and may optionally be driven by firmware and/or software.

Alternatively, in some embodiments, each of the receiving module 414, intercepting module 416, reading module 418, extracting module 420, filtering module 422, aggregating module 424, storing module 426, transferring module 428, querying module 430, tracking module 432, generating module 434, creating module 436, resolving module 438, and the communication module 440 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the DDDPM 406 of FIG. 4 may also be implemented by cloud-based deployment.

In some embodiments, each of the receiving module 414, intercepting module 416, reading module 418, extracting module 420, filtering module 422, aggregating module 424, storing module 426, transferring module 428, querying module 430, tracking module 432, generating module 434, creating module 436, resolving module 438, and the communication module 440 the DDDPM 406 of FIG. 4 may be called via corresponding API, but the disclosure is not limited thereto. For example, in some embodiments, the receiving module 414 may be called via a first API, the intercepting module 416 may be called via a second API, the reading module 418 may be called via a third API, the extracting module 420 may be called via a fourth API, the filtering module 422 may be called via a fifth API, the aggregating module 424 may be called via a sixth API, the storing module 426 may be called via a seventh API, the transferring module 428 may be called via an eight API, the querying module 430 may be called via a ninth API, the tracking module 432 may be called via a tenth API, the generating module 434 may be called via an eleventh API, the creating module 436 may be called via a twelfth API, the resolving module 438 may be called via a thirteenth API, and the communication module 440 may be called via a fourteenth API. In some embodiments, calls may also be made using event-based message interfaces in addition to APIs. An event-based message interface may be a design pattern that enables communication between services by defining events and handlers that process them. This approach may allow for efficient communication and decoupled components, which may lead to more flexible and modular systems.

In some embodiments, the process implemented by the DDDPM 406 may be executed via the communication module 440, and the communication network 410, which may comprise plural networks as described above. In some embodiments, in an exemplary embodiment, the various components of the DDDPM 406 may communicate with the application server 404, the plurality of applications 407(1)-407(n), the distributed database 412, the time series database 413, and the dashboard 415, and other systems of records via the communication module 440 and the communication network 410 and the results may be displayed onto the GUI 442. Of course, these embodiments are merely exemplary and are not limiting or exhaustive. The database(s) 412, 413 may include the databases included within the private cloud and/or public cloud and the server 404 may include one or more servers within the private cloud and the public cloud.

FIG. 5 illustrates a flow chart of a process 500 implemented by the DDDPM 406 of FIG. 4 for automatically capturing detailed database query-level metrics without impacting application performance in accordance with an embodiment. It may be appreciated that the illustrated process 500 and associated steps may be performed in a different order, with illustrated steps omitted, with additional steps added, or with a combination of reordered, combined, omitted, or additional steps.

In some embodiments, the interactions among the components of the DDDPM 406 of FIG. 4 utilizing the steps of FIG. 5, cause the DDDPM 406 to create custom generic code, designed to seamlessly integrate with any application to automatically capture detailed database query-level metrics from the distributed database 412 without impacting performance of the plurality of applications 407(1)-407(n), but the disclosure is not limited thereto.

For example, the DDDPM 406 disclosed herein may be configured to collect information about an infrastructure where an application, i.e., application 407(1)-407(n), is deployed and running, infrastructure where application is connected to execute query (i.e., distributed database node of the distributed database 412), detailed Query level metrics data, application caller details data, query execution time data, query error details data, etc., but the disclosure is not limited thereto. In some embodiments, the DDDPM 406 disclosed herein may also be configured to seamlessly integrate with firmwide metrics tools (not shown) to collect detailed metrics data. The metrics data may then be visualized on the dashboard 415 in real time so that one may take appropriate remedial actions in case of system/application failure.

For example, the DDDPM 406 disclosed herein may be configured to: provide real time monitoring and diagnosing issues, e.g., facilitating real-time tracking of database objects and hardware health in a distributed environment without affecting application performance; timely identify any latency issues at both the node and data center levels, helping in quick resolution to improve overall system performance; accurately identify and pinpoint the root cause of performance issues originating from a database, whether they stem from incorrect data center connections, misconfigured query parameters, or hardware/software malfunctions; significantly improve database related investigative processing time; provide insights into how the execution of one application may affect another, allowing developers to address cascading effects efficiently; optimize data center connections, e.g., identifying that applications connect to the appropriate local data center, minimizing latency; configuring query parameters, e.g., detecting misconfigured query parameters to enhance data retrieval performance, but the disclosure is not limited thereto.

In some embodiments, the DDDPM 406 disclosed herein may be configured to continuously monitor performance metrics associated with one or more applications executing within a distributed database environment spanning multiple data centers. The monitored performance metrics may include, without limitation, query response time, query volume, error counts, timeout rates, dropped mutation rates, storage input/output latency, processor utilization, memory utilization, and network round-trip latency. The monitored metrics may be collected at node-level, cluster-level, and data center-level granularity and may be correlated to a particular application identifier and corresponding database queries issued by that application.

When one or more of the monitored metrics exceed a predetermined threshold or deviates from a baseline performance profile, an alert condition may be generated. In response to the alert condition, the DDDPM 406 disclosed herein may be configured to automatically create a structured remediation ticket. The remediation ticket may comprise a machine-readable data structure including, for example, an application identifier, a data center identifier, one or more affected node identifiers, measured query response time distributions, query volume metrics, error counts, timeout statistics, infrastructure telemetry data, and a classified root-cause indicator. The remediation ticket may further include one or more recommended corrective actions derived from a rules engine, heuristic model, or machine-learned classification model.

In some implementations, the remediation ticket may be programmatically transmitted to an orchestration subsystem, configuration management subsystem, or automated remediation engine. The remediation ticket may serve as an executable control artifact that initiates one or more infrastructure-level corrective operations within the distributed database dynamics corresponding to the application. Such corrective operations may include, without limitation, modifying load-balancing policies to enforce data center locality, redistributing read or write traffic among replica nodes, resizing connection pools, adjusting thread concurrency limits, reconfiguring replication factors, initiating node decommissioning procedures, triggering compaction parameter adjustments, provisioning additional database nodes, or reallocating compute resources within a cloud environment.

By way of example, if the DDDPM 406 determines that application instances within a first data center are issuing database queries to a non-local replica set, thereby increasing network round-trip latency and query response time, the remediation ticket may instruct reconfiguration of locality-aware routing parameters. In another example, if a subset of nodes within a cluster exhibits elevated read latency and increased dropped mutation rates due to storage I/O bottlenecks or memory pressure, the remediation ticket may trigger redistribution of traffic to healthy replicas and dynamic rebalancing of data partitions.

In response to execution of the remediation ticket, the DDDPM 406 disclosed herein may resolve the elevated query response time, abnormal query volume distribution, and increased error counts while maintaining continued operation of the application. In some embodiments, remediation may be performed using rolling configuration updates, quorum-aware traffic redistribution, replica failover procedures, or horizontal scaling operations that are executed without terminating application instances or requiring cluster-wide restart. The DDDPM 406 disclosed herein may be configured to monitor post-remediation metrics to confirm restoration of query response time, volume distribution, and error counts to within acceptable thresholds.

In some embodiments, remediation operations may be performed in a manner that preserves service-level objectives associated with the application. For example, traffic rebalancing may be conducted incrementally to prevent throughput degradation beyond a predefined percentage threshold. Similarly, horizontal scaling operations may be performed concurrently with ongoing query processing, and temporary rate limiting may be selectively applied to lower-priority workloads while maintaining priority scheduling for latency-sensitive API endpoints. Accordingly, the DDDPM 406 disclosed herein may resolve performance degradation within the distributed database dynamics corresponding to the application without compromising application availability, throughput, or consistency guarantees.

In some embodiments, the DDDPM 406 disclosed herein may also be configured to improve operational efficiency. For example, with granular error query analysis, the DDDPM 406 may facilitate early detection and alerting of system anomalies, minimizing downtime and improving system reliability. Automatic resolution may also be integrated with alerts, thereby reducing human intervention and improving overall system performance. Moreover, the DDDPM 406 disclosed herein may be configured to implement intuitive user interface thereby ensuring accessibility for both technical and non-technical stakeholders, promoting cross-functional collaboration and informed decision-making, but the disclosure is not limited thereto.

The interactions among the components of the DDDPM 406 of FIG. 4 utilizing the steps of FIG. 5 are disclosed below.

Referring to FIGS. 4-5, in some embodiments, at step S502, the process 500 may include establishing a communication link, by calling the communication module 440 (see FIG. 4) via the fourteenth API, among the application 407(1)-407(n), the application server 404, the distributed database 412, the timeseries database 413, and the dashboard 415 via the communication network 410 by utilizing the client device 408(1)-408(n) via a communication interface within the GUI 442.

In some embodiments, the DDDPM 406 may be configured to initialize system/method context from application.ymal that may include: filter criteria – establishing the conditions for selecting relevant data; aggregation methods - defining the techniques for combining data; transformation/masking details – specifying how data should be transformed and masked; and enrichment details – outlining additional data enhancements to be applied, etc., but the disclosure is not limited thereto.

In some embodiments, at step S504, the process 500 implemented by the DDDPM 406 may include receiving, by the distributed database 412 by calling the receiving module 414 via the first API, a database query from the application 407(1)-407(n). The distributed database 412 may store application data, e.g., transactional data, profile data, metadata, etc., but the disclosure is not limited thereto.

In some embodiments, at step S506, the process 500 implemented by the DDDPM 406 may include, intercepting by calling the intercepting module 416 via the second API, by the application server 404 via the API service 409, a response including query metrics data from the distributed database 412 corresponding to receiving the database query prior to sending the response to the application and reading the intercepted data by calling the reading module 418 via the third API.

At step S508, the process 500 implemented by the DDDPM 406 may include extracting, by calling the extracting module 420 via the fourth API, essential data from the response for metric object formation and filtering out unnecessary data by calling the filtering module 422 via the fifth API. In some embodiments, the essential data for metric objection formation may include one or more of the following data: data center information data, query details data, status data, execution time data, host internet protocol data, etc., but the disclosure is not limited thereto. In some embodiments, the unnecessary data may include one or more of the following data: specific query types data; responses with a time greater than a configurable threshold, irrelevant metric types data, etc., but the disclosure is not limited thereto.

In some embodiments, after filtering out unnecessary data at step S508, the process 500 implemented by the DDDPM 406 may include enriching the metric object by adding private cloud pool details data, executor details data, and application caller details data, but the disclosure is not limited thereto. Moreover, in some embodiments, after enriching the metric object, the process 500 implemented by the DDDPM 406 may include masking and transforming data from the response including masking personally identifiable information, grouping client identifies to form client groups, and masking host internet protocols to optimize time metric counts.

In some embodiments, at step S510, the process 500 implemented by the DDDPM 406 may include: aggregating by calculating and providing statistical measures corresponding to the extracted essential data by calling the aggregating module 424 via the sixth API generating, and generating aggregated data, by calling the generating module 434 via the eleventh API. In some embodiments, the statistical measures may include minimum values, maximum values, and percentiles (i.e., 90^{th}, 95^{th}, 99^{th}, but not limited thereto) corresponding to a response time of a data center corresponding to the database query from the application 407(1)-407(n).

In some embodiments, at step S512, the process 500 implemented by the DDDPM 406 may include storing, by calling the storing module 426 via the seventh API, the aggregated data in-memory within the application server 404 for accessing and further processing. After storing the aggregated data in-memory within the application server 404 at step S512, the process 500 implemented by the DDDPM 406 may include performing periodic clean-up of outdated metric data from the in-memory data to optimize memory usage.

In some embodiments, at step S514, the process 500 implemented by the DDDPM 406 may include, transferring, by calling the transferring module 428 via the eighth API, the in-memory data from the application server 404 to the timeseries database 413.

In some embodiments, at step S516, the process 500 implemented by the DDDPM 406 may include, querying, by the dashboard, the timeseries database by calling the querying module 430 via the ninth API, and continuously tracking query response times by calling the tracking module 432 via the tenth API.

In some embodiments, at step S518, the process 500 implemented by the DDDPM 406 may include automatically generating an alert, in response to continuously tracking, when it is determined that a query response time, volume, and error counts exceed a configurable threshold, by calling the generating module 434 via the eleventh API. In some embodiments, for query response thresholds, alerts may be generated if a query response time exceeds a specified threshold. For volume thresholds, alerts may be triggered if the query volume surpasses a defined threshold. For error count thresholds, alerts may be issued if the number of errors exceeds an established threshold.

In some embodiments, at step S520, the process 500 implemented by the DDDPM 406 may include creating a ticket, in response to the alert, to take a remedial action to resolve the query response time, volume, and error counts of a data center within the distributed database dynamics corresponding to the application by calling the creating module 436 via the twelfth API.

In some embodiments, at step S522, the process 500 implemented by the DDDPM 406 may include resolving the query response time, volume, and error counts, in response to the ticket, without compromising performance of the application 407(1)-407(n) by calling the resolving module 438 via the thirteenth API and by utilizing the GUI 442.

In some embodiments, the DDDPD 402 may include a memory (e.g., a memory 106 as illustrated in FIG. 1) which may be a non-transitory computer readable medium that may be configured to store instructions for implementing a platform, language, database, and cloud agnostic DDDPM 406 for creating custom generic code, designed to seamlessly integrate with any application to automatically capture detailed database query-level metrics without impacting application performance as disclosed herein. The DDDPD 402 may also include a medium reader (e.g., a medium reader 112 as illustrated in FIG. 1) which may be configured to read any one or more sets of instructions, e.g., software, from any of the memories described herein. The instructions, when executed by a processor embedded within the DDDPM 406 or within the DDDPD 402, may be used to perform one or more of the processes as described herein. In a particular embodiment, the instructions may reside completely, or at least partially, within the memory 106, the medium reader 112, and/or the processor 104 (see FIG. 1) during execution by the DDDPD 402.

In some embodiments, the instructions, when executed, may cause a processor embedded within the DDDPM 406 or the DDDPD 402 to perform the following: establishing a communication link among the application, an application server, a distributed database, a timeseries database, and a dashboard via a communication network; receiving, by the distributed database, a database query from the application; intercepting and reading, by the application server, a response including query metrics data from the distributed database corresponding to receiving the database query prior to sending the response to the application; extracting essential data from the response for metric object formation and filtering out unnecessary data; generating aggregated data by calculating and providing statistical measures corresponding to the extracted essential data; storing the aggregated data in-memory within the application server for accessing and processing; transferring the in-memory data from the application server to the timeseries database; querying, by the dashboard, the timeseries database and continuously tracking query response times; automatically generating an alert, in response to continuously tracking, when it is determined that a query response time, volume, and error counts exceed a configurable threshold; creating a ticket, in response to the alert, to take a remedial action to resolve the query response time, volume, and error counts of a data center within the distributed database dynamics corresponding to the application; and resolving the query response time, volume, and error counts, in response to the ticket, without compromising performance of the application. In some embodiments, the processor may be the same or similar to the processor 104 as illustrated in FIG. 1 or the processor embedded within the DDDPD 202, DDDPD 302, DDDPD 402, and DDDPM 406 which may be the same or similar to the processor 104.

In some embodiments according to the non-transitory computer readable medium, the essential data for metric objection formation may include one or more of the following data: data center information data, query details data, status data, execution time data, host internet protocol data, etc., but the disclosure is not limited thereto.

In some embodiments according to the non-transitory computer readable medium, the unnecessary data may include one or more of the following data: specific query types data; responses with a time greater than a configurable threshold, irrelevant metric types data, etc., but the disclosure is not limited thereto.

In some embodiments, the instructions, when executed, may cause the processor 104 to further perform the following: enriching the metric object by adding private cloud pool details data, executor details data, and application caller details data.

In some embodiments, the instructions, when executed, may cause the processor 104 to further perform the following: masking and transforming data from the response including masking personally identifiable information, grouping client identifies to form client groups, and masking host internet protocols to optimize time metric counts.

In some embodiments according to the non-transitory computer readable medium, the statistical measures may include minimum values, maximum values, percentiles corresponding to a response time of a data center corresponding to the database query from the application, etc., but the disclosure is not limited thereto.

In some embodiments, the instructions, when executed, may cause the processor 104 to further perform the following: performing periodic clean-up of outdated metric data from the in-memory data to optimize memory usage.

In some embodiments according to the non-transitory computer readable medium, the timeseries database may be shared across all services and executors corresponding to the application.

In some embodiments as disclosed above in FIGS. 1-5, technical improvements effected by the instant disclosure may include a platform for implementing a platform, language, database, and cloud agnostic distributed database dynamics provisioning module configured to automatically create custom generic code, designed to seamlessly integrate with any application to automatically capture detailed database query-level metrics without impacting application performance, but the disclosure is not limited thereto. For example, in some embodiments as disclosed above in FIGS. 1-5, technical improvements effected by the instant disclosure may include a platform for implementing a platform, language, database, and cloud agnostic distributed database dynamics provisioning module configured to collect information about an infrastructure where an application is deployed and running, infrastructure where application is connected to execute query (i.e., distributed database node), detailed Query level metrics data, application caller details data, query execution time data, query error details data, etc., but the disclosure is not limited thereto. In some embodiments, the distributed database dynamics provisioning module disclosed herein may also be configured to seamlessly integrate with firmwide metrics tool to collect detailed metrics. The metrics may then be visualized on a dashboard in real time.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, method, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or method described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it may not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for provisioning distributed database dynamics corresponding to an application by utilizing one or more processors along with allocated memory, the method comprising:
establishing a communication link among the application, an application server, a distributed database, a timeseries database, and a dashboard via a communication network;
receiving, by the distributed database, a database query from the application;
intercepting and reading, by the application server, a response including query metrics data from the distributed database corresponding to receiving the database query prior to sending the response to the application;
extracting essential data from the response for metric object formation and filtering out unnecessary data;
generating aggregated data by calculating and providing statistical measures corresponding to the extracted essential data;
storing the aggregated data in-memory within the application server for accessing and processing;
transferring the in-memory data from the application server to the timeseries database;
querying, by the dashboard, the timeseries database and continuously tracking query response times;
automatically generating an alert, in response to continuously tracking, when it is determined that a query response time, volume, and error counts exceed a configurable threshold;
creating a ticket, in response to the alert, to take a remedial action to resolve the query response time, volume, and error counts of a data center within the distributed database dynamics corresponding to the application; and
resolving the query response time, volume, and error counts, in response to the ticket, without compromising performance of the application.

2. The method of claim 1, wherein the essential data for metric objection formation include one or more of the following data: data center information data, query details data, status data, execution time data, and host internet protocol data.

3. The method of claim 1, wherein the unnecessary data includes one or more of the following data: specific query types data; responses with a time greater than a configurable threshold, and irrelevant metric types data.

4. The method of claim 1, further comprising:
enriching the metric object by adding private cloud pool details data, executor details data, and application caller details data.

5. The method of claim 1, further comprising:
masking and transforming data from the response including masking personally identifiable information, grouping client identifies to form client groups, and masking host internet protocols to optimize time metric counts.

6. The method of claim 1, wherein the statistical measures includes minimum values, maximum values, and percentiles corresponding to a response time of a data center corresponding to the database query from the application.

7. The method of claim 1, further comprising:
performing periodic clean-up of outdated metric data from the in-memory data to optimize memory usage.

8. The method according to claim 1, wherein the timeseries database is shared across all services and executors corresponding to the application.

9. A system for provisioning distributed database dynamics corresponding to an application, the system comprising:
a processor; and
a memory operatively connected to the processor via a communication interface, the memory storing computer readable instructions that, when executed, cause the processor to:
establish a communication link among the application, an application server, a distributed database, a timeseries database, and a dashboard via a communication network;
receive, by the distributed database, a database query from the application;
intercept and read, by the application server, a response including query metrics data from the distributed database corresponding to receiving the database query prior to sending the response to the application;
extract essential data from the response for metric object formation and filter out unnecessary data;
generate aggregated data by calculating and providing statistical measures corresponding to the extracted essential data;
store the aggregated data in-memory within the application server for accessing and processing;
transfer the in-memory data from the application server to the timeseries database;
query, by the dashboard, the timeseries database and continuously tracking query response times;
automatically generate an alert, in response to continuously tracking, when it is determined that a query response time, volume, and error counts exceed a configurable threshold;
create a ticket, in response to the alert, to take a remedial action to resolve the query response time, volume, and error counts of a data center within the distributed database dynamics corresponding to the application; and
resolve the query response time, volume, and error counts, in response to the ticket, without compromising performance of the application.

10. The system of claim 9, wherein the essential data for metric objection formation include one or more of the following data: data center information data, query details data, status data, execution time data, and host internet protocol data.

11. The system of claim 9, wherein the unnecessary data includes one or more of the following data: specific query types data; responses with a time greater than a configurable threshold, and irrelevant metric types data.

12. The system of claim 9, wherein the processor is further configured to:
enriching the metric object by adding private cloud pool details data, executor details data, and application caller details data.

13. The system of claim 9, wherein the processor is further configured to:
mask and transform data from the response including masking personally identifiable information, grouping client identifies to form client groups, and mask host internet protocols to optimize time metric counts.

14. The system of claim 9, wherein the statistical measures includes minimum values, maximum values, and percentiles corresponding to a response time of a data center corresponding to the database query from the application.

15. The system of claim 9, wherein the processor is further configured to:
perform periodic clean-up of outdated metric data from the in-memory data to optimize memory usage.

16. The system according to claim 9, wherein the timeseries database is shared across all services and executors corresponding to the application.

17. A non-transitory computer readable medium configured to store instructions for provisioning distributed database dynamics corresponding to an application, the instructions, when executed, cause a processor to perform the following:
establishing a communication link among the application, an application server, a distributed database, a timeseries database, and a dashboard via a communication network;
receiving, by the distributed database, a database query from the application;
intercepting and reading, by the application server, a response including query metrics data from the distributed database corresponding to receiving the database query prior to sending the response to the application;
extracting essential data from the response for metric object formation and filtering out unnecessary data;
generating aggregated data by calculating and providing statistical measures corresponding to the extracted essential data;
storing the aggregated data in-memory within the application server for accessing and processing;
transferring the in-memory data from the application server to the timeseries database;
querying, by the dashboard, the timeseries database and continuously tracking query response times;
automatically generating an alert, in response to continuously tracking, when it is determined that a query response time, volume, and error counts exceed a configurable threshold;
creating a ticket, in response to the alert, to take a remedial action to resolve the query response time, volume, and error counts of a data center within the distributed database dynamics corresponding to the application; and
resolving the query response time, volume, and error counts, in response to the ticket, without compromising performance of the application.

18. The non-transitory computer readable medium of claim 17, wherein the essential data for metric objection formation include one or more of the following data: data center information data, query details data, status data, execution time data, and host internet protocol data.

19. The non-transitory computer readable medium of claim 17, wherein the unnecessary data includes one or more of the following data: specific query types data; responses with a time greater than a configurable threshold, and irrelevant metric types data.

20. The non-transitory computer readable medium of claim 17, wherein the instructions, when executed, cause the processor to further perform the following:
enriching the metric object by adding private cloud pool details data, executor details data, and application caller details data.
